(19) United States
(12) Patent Application Publication
(10) Pub. No.: US 2011/0223296 A1
(43) Pub. Date: Sep. 15, 2011

(54) SANDWICH COOKING ACCESSORY

(75) Inventors: Donald William Bryce, Natick, MA (US); Robert Scott Ashworth, Littleton, MA (US); Wing Sun (Felix) Wong, Ashland, MA (US); Kris David Kahn, Boston, MA (US); Paul Santarsiero, Avon, CT (US)

(73) Assignee: JORDAN KAHN COMPANY, Newton, MA (US)

(21) Appl. No.: 12/764,267

(22) Filed: Apr. 21, 2010

Related U.S. Application Data
(60) Provisional application No. 61/312,770, filed on Mar. 11, 2010.

(51) Int. Cl. A23L 1/01; A47J 37/07

(52) U.S. Cl. 426/274; 99/450; 426/523

(57) ABSTRACT

Disclosed is a sandwich cooking accessory having a plurality of pockets in which may be assembled a sandwich or into which may be placed a raw (not yet cooked) sandwich. The accessory also includes a panel engagable to the pockets to contain the assembled sandwiches during handling and cooking. The panel cooperates with the pockets to slightly, but not excessively, compress the sandwiches. The pockets and panel are perforated to enable heat to the sandwiches during cooking. The panel include a plurality of shield to protect certain portions of the sandwiches from excessive toasting during cooking.

### RELATED APPLICATION

This application is a Continuation of and claims the benefit of pending U.S. Provisional Application Ser. No. 61/312770, filed Mar. 11, 2010, the entire teachings of which are incorporated herein by reference.

### FIELD OF THE INVENTION

The present invention is related to cooking and to accessories therefore. More specifically, this invention is related to a cooking accessory for use on a barbeque grill, in a toaster oven, in an baking oven, or over an open flame, which enables and improves the cooking of sandwiches, especially cookie sandwiches such as s'mores.

### BACKGROUND

S'mores cookie sandwiches are a well known treat, typically made of one or two marshmallows and a small slab of milk chocolate sandwiched between two graham crackers, which is all then cooked until the marshmallow and chocolate soften and begin to melt. Preferably, the peripheries of the graham crackers are slightly toasted during cooking. Also preferably, the crackers are compressed slightly, but not excessively, during cooking, so that the marshmallow and chocolate are spread to the edges of the crackers but not squeezed out of the sandwich. Also preferably, the crackers are maintained parallel to each other during cooking so that the marshmallow and chocolate there-between is distributed evenly.

Numerous other types of sandwiches are cooked, either to warm ingredients, enhance flavor, melt included cheese, or cause toasting. Similar problems must be overcome for optimal preparation and cooking of such sandwiches.

Also among the tasks which need improvement in preparing and cooking s'mores and other sandwiches are included the assembling of the sandwich, and the maintenance of the sandwich in its assembled state during movement into the cooking apparatus, during cooking, and during removal.

Among the problems specific to s'mores is the inability of any device or method to-date to effectively aid in the afore-mentioned assembling, compressing, maintenance, and handling, so that a s'mores sandwich cookie is consistently produced in which the peripheries of the graham crackers are slightly toasted, the marshmallow and chocolate are spread to the edges of the crackers but not squeezed out of the sandwich, and the crackers are parallel to each other with the marshmallow and chocolate there-between distributed evenly.

There exists a need for improvement in the function, convenience, and methodology of preparing and cooking sandwiches and solving the above-stated problems, and such are among the objects of the present invention. More specifically, there exists a need for an improvement in the function, convenience, and methodology of preparing and cooking s'mores cookie sandwiches and solving the above-stated problems, and such are among the objects of the present invention.

Further needs and objects exist which are addressed by the present invention, as may become apparent upon review of the included disclosure of exemplary embodiments thereof.

### SUMMARY OF THE INVENTION

The invention may be practiced in a cooking accessory having one or more pockets in which may be assembled a sandwich or into which may be placed a raw (not yet cooked) sandwich. Among other things, the invention may lie in the device or in the method for using it.

The accessory may include a panel engagable to the pocket to contain the assembled sandwich during handling and cooking. The panel may cooperate with the pocket to slightly, but not excessively, compress the sandwich. The pocket and/or the panel may be perforated to enable heat to the sandwich during cooking. The pocket and/or panel may include a shield to protect certain portions of the sandwich from excessive toasting during cooking.

The device may include spacing means to distance the sandwich from the heat source of the cooking device during cooking to enhance cooking quality. The device may serve a secondary function as a convenient serving tray after cooking. More specifically, the panel may serve as this serving tray.

The device may be adapted for easy removal of the cooked sandwiches and for easy cleaning such as by employing a non-stick coating. The device may be further adapted for easy cleaning by being adapted for rinsing under a kitchen faucet or placing in a dishwasher.

The invention may be practiced as a method for preparing a cooked sandwich including the steps of assembling a raw sandwich, placing the raw sandwich into a perforated pocket of a cover through an opened top of the pocket, engaging a panel and the pocket both to cover the opened top and to compress the raw sandwich between the pocket and panel, and heating the raw sandwich in the engaged panel and pocket to convert the raw sandwich to a cooked sandwich.

The panel may include a heat shield and the step of heating the raw sandwich may be preceded by the further step of placing the raw sandwich in the engaged panel and pocket over a source of heat with the heat shield between the raw sandwich and the source of heat.

The step of placing the raw sandwich may include flipping the raw sandwich in the engaged panel and pocket. The step of assembling the raw sandwich may include placing a marshmallow and a piece of chocolate between two graham crackers.

The panel may be hingedly connected to the pocket and movable between an open state wherein the panel does not cover the opened top and a closed state wherein the panel covers the opened top, and the step of engaging the panel to the pocket may include pivoting the panel from the opened state to the closed state.

One of the panel and the pocket may include a connector for securing the panel to the pocket when the panel is in the closed state, and the step of engaging the panel to the pocket may further include securing the panel to the pocket by the connector.

The invention may also be practiced as a method for preparing a cooked sandwich including the steps of assembling the raw sandwich within the perforated pocket of the cover through the opened top of the pocket, and otherwise following the steps outlines above to convert the raw sandwich to the cooked sandwich.

The invention may also be practiced in a device for enabling the cooking of sandwiches including a metal cover having a rectilinear pocket with a perforated bottom and an opened top, and having sidewalls forming an approximate square of approximately 2.5 inches, together with a metal panel engagable with the pocket to cover the opened top, such that the panel, when engaged to the pocket, is parallel to and separated from the perforated bottom by approximately between 1.2 and 1.5 inches.

The cover and panel may be pivotably affixed at a hinge and relatively movable about the hinge between an open state wherein the panel is not engaged with the pocket and the opened top is exposed, and a closed stated wherein the panel is engaged with the pocket. One of the cover and the panel may include a connector for engaging the panel with the pocket, the connector including a flexible metal clip.

Further features and aspects of the invention are disclosed with more specificity in the Detailed Description and accompanying drawings of an exemplary embodiment provided herein.

### BRIEF DESCRIPTION OF THE DRAWINGS

Many aspects of the invention can be better understood with reference to the included Drawings showing exemplary embodiments for practicing the invention which correspond to the accompanying Detailed Description. The components in the Drawings are not necessarily to scale, emphasis instead being placed upon clearly illustrating the principles of the invention. Moreover, like reference numerals in the Drawings designate corresponding parts throughout the several views.

FIG. 1 is a top perspective view of a cooking accessory according to a first exemplary embodiment for practicing the invention;

FIG. 2 is a perspective view showing the loading of raw s'mores cookie sandwiches into the accessory of FIG. 1;

FIG. 3 is a top view of the accessory of FIG. 1;

FIG. 4 is a bottom perspective view of the accessory of FIG. 1;

FIGS. 5A and 5B are a sequence of partial cross-sectional views through the clip of accessory of FIG. 1 during closing;

FIG. 6 is a partial cross-sectional view through a hinge of the accessory of FIG. 1; and

FIG. 7 is a top perspective view of a cooking accessory according to a second exemplary embodiment for practicing the invention.

### DETAILED DESCRIPTION OF AN EXEMPLARY EMBODIMENT

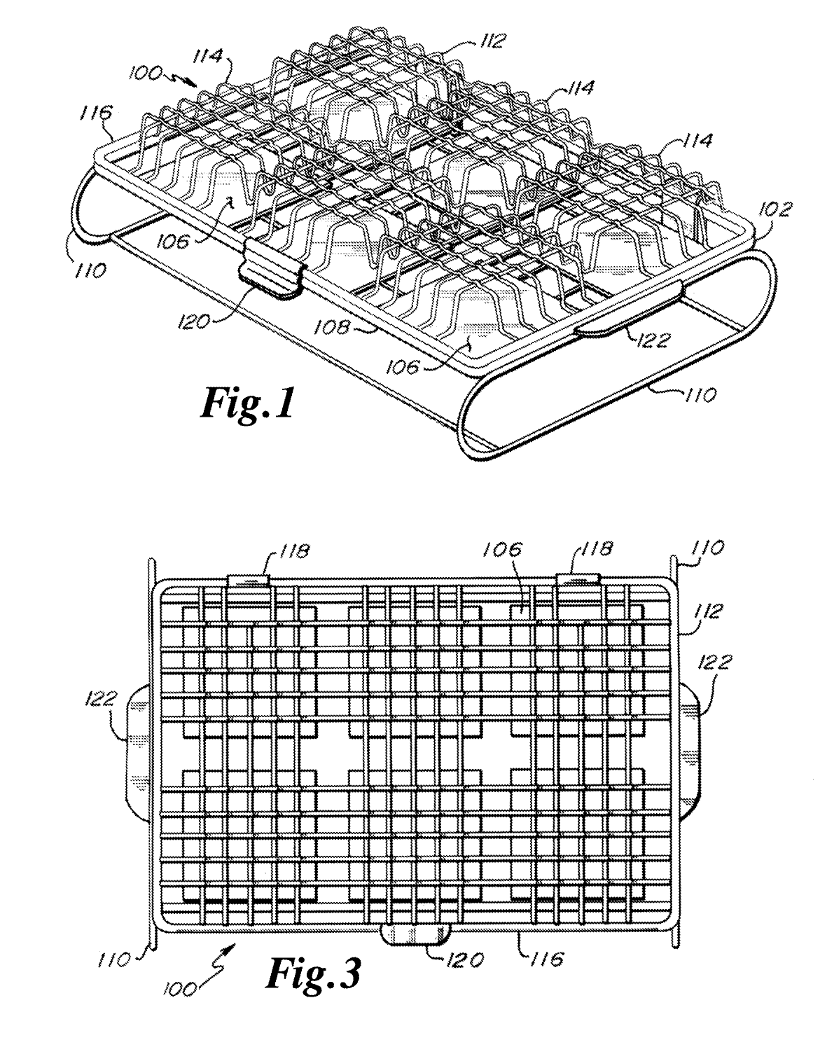

A first exemplary embodiment of a cooking accessory 100 is shown in FIGS. 1 through 6, which enables and improves the cooking of food items such as s'mores cookie sandwiches.

The accessory includes a perforated base 102 in the form of a panel 104 having disposed thereon an array of shields 106. The base is preferably made of welded or weaved metal wiring within a rectangular metal wire base frame 108 . . . preferably all made of stainless steel or nonstick-coated steel. The base frame is supported by a two-legged stand 110 which maintains the base approximately two inches above a supporting surface, such as the grill of a barbeque. When placed into an oven, the spacing of the base frame off the supporting surface allows heated air to fully circulate under the base. The base may alternatively be made of expanded or perforated sheet metal.

The shields are preferably square in shape, between 2″×2″ and 2.4″×2.4″, and made of sheet metal that is welded or otherwise affixed to the base. When a non-stick coating is to be used and the base, stand and shields are all to be welded together, coating should preferably be applied after welding. When the shields are otherwise affixed to the base such as by some fasteners, coating may be better applied prior to affixation.

In the alternative case where the base is made of expanded or perforated sheet metal, the shields may alternatively be formed integrally therewith by leaving non-perforated zones in the sheet metal in the same areas and having the same shapes.

The accessory also includes a perforated cover 112 having configured integrally therein an array of preferably rectilinear pockets 114 or compartments. The cover is preferably made of welded or weaved metal wiring within a rectangular metal wire cover frame 116 similar in size and shape to the base frame . . . and also preferably all made of stainless steel or nonstick-coated steel. The cover may alternatively be made of expanded or perforated sheet metal.

The pocket array of the cover is the same as the shield array of the base in number, position, and preferably approximately in shape. The pockets are preferably each sized to receive an uncooked s'mores cookie sandwich, which typically measures approximately 2.5″ Square, by approximately 1.5″ tall. So the pockets are preferably approximately just over 2.5″ square and just less than 1.5″ deep. As explained below, it is preferable to have the pockets just shallower than the height of the uncooked s'mores.

The cover is pivotably connected along one side of its cover frame to a matching side of the base frame by two hinges 118. The hinges are loops of metal loosely surrounding the base frame and cover frame and allow sufficient slop so that the frames may be slightly separated during pivoted, as shown in FIG. 6. This allows both the cover and the stand to simultaneously rest on the same support surface when they are swung fully apart.

On the side of the cover frame opposite the hinged connection, a flexible clip 120 is affixed to the cover frame which is adapted to capture the base frame and thereby, in cooperation with the hinged connection, secure the cover to the base as seen in FIG. 1. Handles 122 are affixed to each opposing end of the base frame, to enable carrying of the device.

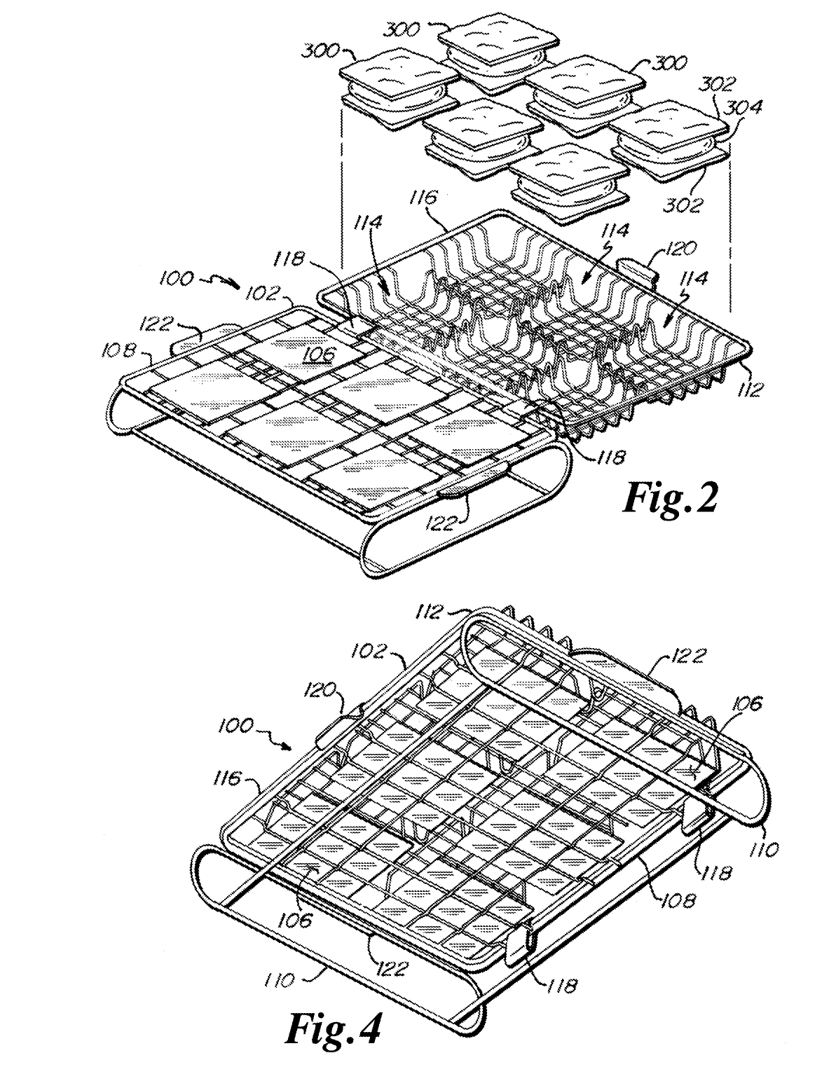

By manually flexing the cover's clip outwardly to temporarily release the clip from the base frame, the cover and base may be swung apart and one of the base and cover may be flipped relative to the other approximately one-hundred and eighty angular degrees. As shown in FIG. 2, when the pockets are to be loaded with uncooked s'mores 300, the cover is set down on the support surface and the base is flipped relative to it so that the pockets become upwardly exposed. Later, when the cooked s'mores are to be removed, the base will be set down on the support surface and the cover will be flipped relative to it so that the base may be used as a serving tray.

The clip may alternatively be affixed to the base frame and arranged to capture and release the cover frame in equivalent fashion.

To use the device, the cover is first opened as in FIG. 2, so that each pocket is upwardly exposed, and a graham cracker 302 is placed into each pocket. A marshmallow and a slab of chocolate, together 304, are placed atop each cracker, and another cracker 302 is added to assemble a plurality of raw s'mores cookie sandwiches in each pocket. The shape of the pocket confines the stacked ingredients into the proper arrangement even if the accessory is lifted and moved about.

Alternatively, the plurality of uncooked s'mores sandwiches 300 may first be assembled aside from the device, the cover opened as in FIG. 2, and the assembled uncooked s'mores may be gently placed down into the upwardly exposed pockets in the swung-opened cover.

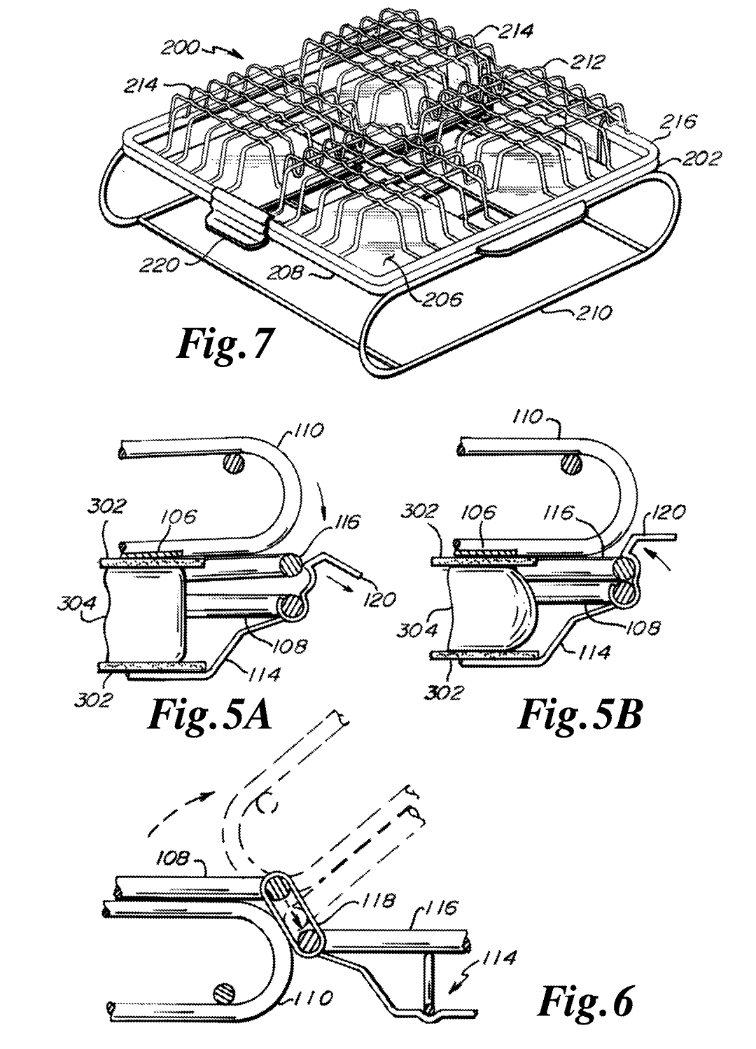

While maintaining the cover in its upside-down state, the base is next swing over until the flexible clip of the cover is forced outward by the interfering base frame as seen in FIG. 5A, and snaps back around the frame as seen in FIG. 5B, to secure the base and cover back together . . . all upside down.

Next, the entire assembly of the secured cover and base with the uncooked s'mores trapped inside the pockets is flipped back over to its normal upright disposition and either placed aside, such as in the refrigerator for later cooking, or directly into or onto the cooking device.

As seen by comparison of FIGS. 5A and 5B, the raw sandwich assembly is slightly compressed between the shields of the base and the pockets, so that the marshmallows are caused to slightly bulge. In this way, the elasticity of the marshmallows is employed to secure the sandwich assemblies within the device and maintain them in the proper assembled state during movement, even when the device is flipped over. The marshmallows are found to be ideally soft and resilient so that the crackers do not break as the raw sandwiches are compressed, but still firm enough to hold the assembled sandwiches within the device during typical movement.

As previously mentioned, the depth of the pockets in the assembled cover and base (the distance from the top of each pocket and its associated shield) is preferably just less that 1.5″, so that the uncooked s'mores are slightly and gently compressed as the base and cover are secured together, but not compressed so much as to cause the marshmallows and chocolate to be squeezed out of the crackers during cooking. This holds them securely together during flipping and handling.

Pockets that are too deep would allow the s'mores to easily shift around and fall apart prior to cooking, and thereby make a mess. Pockets that are too shallow will either cause the closing of the base and cover to break the s'more crackers apart and make a crummy mess, or will cause the softening marshmallow and chocolate to be excessively squeezed out from between the crackers during cooking, and thereby make a gooey mess.

The size and position of the shields relative to the adjacent crackers is such that a bit of the cracker periphery overhangs the shield. This allows toasting of the periphery of the crackers during cooking, but keeps the center portion of the cracker from toasting, so that the crackers will not become overly brittle, which would cause the sandwich to break apart when it is bitten.

The assembly is next placed into or on the heat source for cooking until the marshmallow and chocolate have softened and are just on the verge of beginning to melt. The ideal cooked s'mores sandwich will be solid in the hand, marshmallow and chocolate soft, slightly gooey, and bulging to the cracker edges, not drippy, crackers slightly toasted around their edges but not burnt, and crackers not so hot that the sandwich cannot be eaten while the marshmallow and chocolate are still warm and soft. Obtaining such an ideal s'mores has previously been a rare case of circumstance and luck. With the present invention, it is a predictable routine.

During cooking over an open flame or on a barbeque grill, the shields prevent the crackers from being charred while allowing their shield-overhanging peripheral edges to be handsomely and deliciously toasted. The base stand ensures that the s'mores are separated high enough above the intensity of the heat source so that cooking will be slowed to allow the marshmallow and chocolate to warm and soften before the edges of the crackers are over-toasted. The slight compression of the sandwiches between the cover pockets and shields causes the softening marshmallows and chocolate to bulge outwardly to almost perfectly match the edges of the crackers, thereby providing and appetizing appearance and a portion of marshmallow and chocolate in every bite.

During cooking in a toaster oven or baking oven, the shields prevent the crackers from being overcooked while allowing their shield-overhanging peripheral edges to be handsomely and deliciously toasted. The base stand provides a space below the cooking sandwiches for heated air to access the entirety of each cookie.

While cooking the s'mores on a barbeque grill typically requires some attention to determine when they are properly cooked, it is found that s'mores cooked in a toaster oven or baking oven are most ideal when cooked at approximately 350 F for approximately 5 minutes.

Once the s'mores are cooked, the accessory is removed from the cooking device and, while maintaining the base in its upright position, the clip is forced outwardly to release the cover frame and the cover is swung to its opened position. The cooked s'mores are now neatly and proudly disposed atop the base, which may be used as a serving tray. Since the stand is made of reasonably thin wiring, it cools quickly once removed from the heat source so that the device can soon be placed on a table without causing damage . . . long before the s'mores have gotten cold.

After removing and eating the cooked s'mores, the device is easily cleaned in a dishwasher. Its shape is such that multiple devices make be stacked for reduced use of storage space, with the cover pockets of a lower device fitting within the gap formed within the base stand of the device above.

While FIGS. 1-6 show an embodiment having six pockets and thereby capable of making six s'mores at a time, the number of pockets is not a critical aspect of the invention. FIG. 7 shows a second embodiment 200 otherwise similar to the first embodiment except having four pockets, and thereby capable of being used to cook only four s'mores, but useable in a smaller cooking device.

Various changes in form and detail may be made without departing from the spirit and scope of the invention, so the invention should therefore only be considered according to the following claims, including all equivalent interpretation to which they are entitled.

We claim:

1. A method for preparing a cooked sandwich comprising the steps of;
assembling a raw sandwich;
placing the raw sandwich into a perforated pocket of a cover through an opened top of the pocket;
engaging a panel and the pocket both to cover the opened top and to compress the raw sandwich between the pocket and panel; and
heating the raw sandwich in the engaged panel and pocket to convert the raw sandwich to a cooked sandwich.

2. The method of claim 1 wherein the panel comprises a heat shield and the step of heating the raw sandwich is preceded by the further step of placing the raw sandwich in the engaged panel and pocket over a source of heat with the heat shield between the raw sandwich and the source of heat.

3. The method of claim 2 wherein the step of placing the raw sandwich comprises flipping the raw sandwich in the engaged panel and pocket.

4. The method of claim 3 wherein the step of assembling a raw sandwich comprises placing a marshmallow and a piece of chocolate between two graham crackers.

5. The method of claim 1 wherein the panel is hingedly connected to the pocket and movable between an open state wherein the panel does not cover the opened top and a closed state wherein the panel covers the opened top and wherein the step of engaging the panel to the pocket comprises pivoting the panel from the opened state to the closed state.

6. The method of claim 5 wherein one of the panel and the pocket comprises a connector for securing the panel to the pocket when the panel is in the closed state, and wherein the step of engaging the panel to the pocket further comprises securing the panel to the pocket by the connector.

7. The method of claim 6 wherein the panel comprises a heat shield and the step of heating the raw sandwich is preceded by the further step of placing the raw sandwich in the engaged panel and pocket over a source of heat with the heat shield between the raw sandwich and the source of heat.

8. The method of claim 7 wherein the step of placing the raw sandwich comprises flipping the raw sandwich in the engaged panel and pocket.

9. The method of claim 8 wherein the step of assembling a raw sandwich comprises placing a marshmallow and a piece of chocolate between two graham crackers.

10. A method for preparing a cooked sandwich comprising the steps of;
assembling a raw sandwich within a perforated pocket of a cover through an opened top of the pocket;
engaging a panel and the pocket both to cover the opened top and to compress the raw sandwich between the pocket and panel; and
heating the raw sandwich in the engaged panel and pocket to convert the raw sandwich to a cooked sandwich.

11. The method of claim 10 wherein the panel comprises a heat shield and the step of heating the raw sandwich is preceded by the further step of placing the raw sandwich in the engaged panel and pocket over a source of heat with the heat shield between the raw sandwich and the source of heat.

12. The method of claim 11 wherein the step of placing the raw sandwich comprises flipping the raw sandwich in the engaged panel and pocket.

13. The method of claim 12 wherein the step of assembling a raw sandwich comprises placing a marshmallow and a piece of chocolate between two graham crackers.

14. The method of claim 10 wherein the panel is hingedly connected to the pocket and movable between an open state wherein the panel does not cover the opened top and a closed state wherein the panel covers the opened top and wherein the step of engaging the panel to the pocket comprises pivoting the panel from the opened state to the closed state.

15. The method of claim 14 wherein one of the panel and the pocket comprises a connector for securing the panel to the pocket when the panel is in the closed state, and wherein the step of engaging the panel to the pocket further comprises securing the panel to the pocket by the connector.

16. The method of claim 15 wherein the panel comprises a heat shield and the step of heating the raw sandwich is preceded by the further step of placing the raw sandwich in the engaged panel and pocket over a source of heat with the heat shield between the raw sandwich and the source of heat.

17. The method of claim 16 wherein the step of placing the raw sandwich comprises flipping the raw sandwich in the engaged panel and pocket.

18. The method of claim 17 wherein the step of assembling a raw sandwich comprises placing a marshmallow and a piece of chocolate between two graham crackers.

19. A device for enabling the cooking of sandwiches comprising:
a metal cover having a rectilinear pocket with a perforated bottom and an opened top, and having sidewalls forming an approximate square of approximately 2.5 inches;
a metal panel engagable with the pocket to cover the opened top, such that the panel, when engaged to the pocket, is parallel to and separated from the perforated bottom by approximately between 1.2 and 1.5 inches.

20. The device of claim 19 wherein said cover and panel are pivotably affixed at a hinge and relatively movable about the hinge between an open state wherein the panel is not engaged with the pocket and the opened top is exposed, and a closed stated wherein the panel is engaged with the pocket.

21. The device of claim 20 wherein one of the cover and the panel comprises a connector for engaging the panel with the pocket, the connector comprising a flexible metal clip.
